(19) United States
(12) Patent Application Publication
(10) Pub. No.: US 2021/0078564 A1
(43) Pub. Date: Mar. 18, 2021

(54) HYBRID VEHICLE

(71) Applicant: TOYOTA JIDOSHA KABUSHIKI KAISHA, Toyota-shi (JP)

(72) Inventor: Yuki Ogawa, Toyota-shi (JP)

(73) Assignee: TOYOTA JIDOSHA KABUSHIKI KAISHA, Toyota-shi (JP)

(21) Appl. No.: 17/011,671

(22) Filed: Sep. 3, 2020

(30) Foreign Application Priority Data
Sep. 18, 2019 (JP) 2019-169484

(51) Int. Cl. B60W 20/12; G01C 21/34; G01C 21/00; B60L 58/13

(52) U.S. Cl. CPC B60W 20/12; G01C 21/3415; B60W 2556/50; B60L 58/13; G01C 21/3804

(57) ABSTRACT

The hybrid vehicle includes an engine, a motor, a battery, and map information. The hybrid vehicle also includes a control device that sets a drive route from a current location to a destination, creates a drive support plan that assigns one of drive modes including a CD mode and a CS mode to each of drive sections of the drive route, and performs drive support control. The control device generates read-ahead information that is required for creation of the drive support plan, based on road traffic information at every predetermined timing. On the other hand, the control device performs the drive support plan that is based on the read-ahead information generated immediately before a start of update of the map information, during the update of the map information by exterior communication.

### CROSS-REFERENCE TO RELATED APPLICATIONS

The present disclosure claims priority to Japanese Patent Application No. 2019-169484 filed Sep. 18, 2019, which is incorporated herein by reference in its entirety including specification, drawings and claims.

### TECHNICAL FIELD

The present disclosure relates to a hybrid vehicle for managing an application of a plurality of drive modes.

### BACKGROUND

A conventionally known hybrid vehicle of this type performs a drive support control for driving the hybrid vehicle along with a drive support plan in each of drive sections of a drive route from a current location to a destination (as described in, for example, JP2014-151760A). The drive support plan is created by assigning one of a motor drive (EV drive) mode in which an engine is stopped and the hybrid vehicle is driven with a power from a motor, and a hybrid drive (HV drive) mode in which the hybrid vehicle is driven with a power from an engine and a power from a motor during operation of the engine. The drive support plan is created to assign the motor drive mode and the hybrid drive mode such that a state of charge SOC (SOC: State of Charge) that is a ratio of remaining capacity of a battery becomes equal to a value 0 when the hybrid vehicle reaches the destination.

### SUMMARY

Preferably, a drive support plan is created by calculating energy consumption of each of drive sections of a drive route based on road traffic information. The road traffic information includes, for example, information on current and future traffic congestion, information on predicted values of current average vehicle speed and future average vehicle speed in each of drive sections of the drive route, information on traffic regulation, information on weather conditions, information on road conditions, and map information. The road traffic information can be obtained by communicating with an external traffic information management center or the like. The drive support plan is recreated when the road traffic information is updated or when driving state of a vehicle is changed. A map information used for the drive support control is updated by communication with the external traffic information management center as necessary. A part of the function is often stopped during update of the map information. This is because it takes some time to update the map information, and it is necessary to promptly terminate the update. When the map information is updated during the drive support control, it may become difficult to perform appropriate drive support control depending on the function stopped during the update of the map information. In this case, the drive support control may have to be terminated.

A hybrid vehicle of the present disclosure mainly aims to continue the drive support control even while the map information is updated.

In order to achieve the above main object, the hybrid vehicle of the present disclosure employs the following configuration.

The present disclosure is directed to a hybrid vehicle. The hybrid vehicle includes an engine, a motor, a battery, map information, and a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan. The control device includes a device configured to generate read-ahead information that is required for creation of the drive support plan, based on road traffic information at every predetermined timing and to perform a drive support plan that is based on the read-ahead information generated immediately before a start of update of the map information, during the update of the map information by exterior communication.

The hybrid vehicle of the present disclosure sets the drive route from the current location to the destination and creates the drive support plan that assigns one of drive modes including the CD mode and the CS mode to each of drive sections of the drive route. The hybrid vehicle of the present disclosure performs the drive support control for driving the hybrid vehicle along the drive support plan. The CD mode (Charge Depleting mode) gives a priority to a motor drive (EV drive) to reduce a state of charge SOC of the battery. The CS mode (Charge Sustaining mode) uses the motor drive and a hybrid drive (HV drive) in combination to maintain the state of charge SOC of the battery. In the motor drive, the hybrid vehicle is driven only by the power from the motor while the engine is stopped. In the hybrid drive, the hybrid vehicle is driven by the power from the engine and the motor during operation of the engine. The drive support plan is created by using the read-ahead information generated based on the road traffic information at every predetermined timing. During update of map information by exterior communication, the drive support control performs the drive support plan based on the read-ahead information generated immediately before a start of update of the map information. Even if the read-ahead information cannot be generated during the update of the map information, the drive support plan based on the read-ahead information generated immediately before the map information is updated is performed. Accordingly, the drive support control can be continued. The “read-ahead information” includes information on current or future traffic congestion for each drive section, information on current average vehicle speed and predicted value of future average vehicle speed, information on traffic regulation, information on weather conditions, information on road conditions, information on driving load, load information necessary for driving each drive section based on vehicle speed of the own vehicle, driving power of the own vehicle, and drive mode of the own vehicle. The road traffic information may be obtained by exterior communication. The road traffic information may also be stored in the control device.

### BRIEF DESCRIPTION OF DRAWINGS

FIG. 1 is a block diagram illustrating an example of a configuration of a hybrid vehicle focusing on a hybrid electronic control unit according to an embodiment of the present disclosure;

FIG. 2 is a flow chart showing one example of a drive support control performed by the hybrid electronic control unit;

FIG. 3 is a flowchart showing one example of a read-ahead information generation and transmission process performed by a navigation system, and

FIG. 4 is a flow chart showing one example of an alive counter process performed by the hybrid electronic control unit.

### DESCRIPTION OF EMBODIMENTS

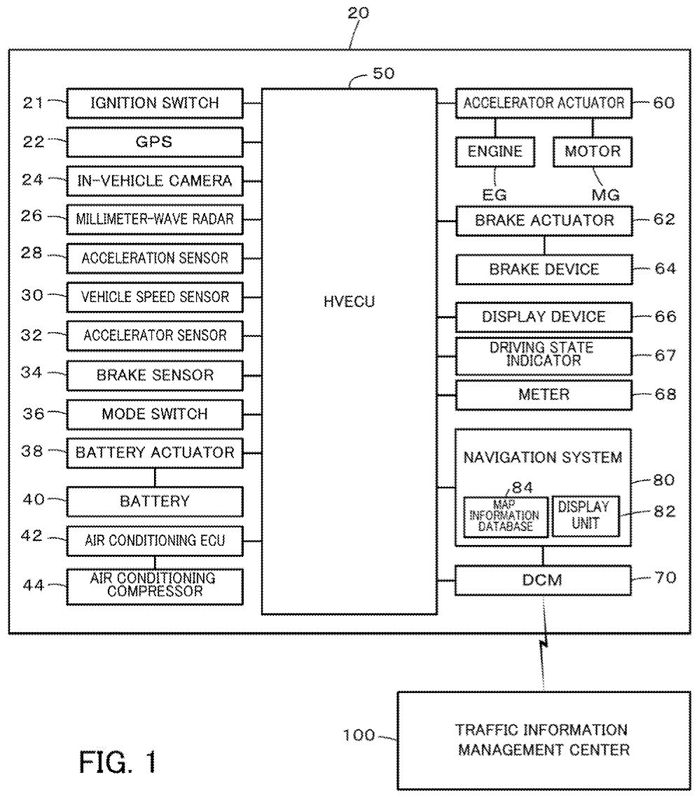

FIG. 1 is a block diagram illustrating an example of a configuration of a hybrid vehicle 20 focusing on a hybrid electronic control unit (hereinafter referred as “HVECU”) 50 according to an embodiment of the present disclosure. The hybrid vehicle 20 of the embodiment includes an engine EG and a motor MG as a power source. The hybrid vehicle 20 of the embodiment is driven by switching between a CD mode (Charge Depleting mode) and a CS mode (Charge Sustaining mode). In the CD mode, the motor drive is prioritized to reduce the state of charge SOC of a battery 40. In the CS mode, the motor drive and the hybrid drive are combined to maintain the state of charge SOC of the battery 40 at a target ratio. In the motor drive, the hybrid vehicle 20 is driven only by the power from the motor MG while the engine EG is stopped. In the hybrid drive, the hybrid vehicle 20 is driven by the power from the engine EG and the motor MG during operation of the engine 20.

The hybrid vehicle 20 of the embodiment includes an ignition switch 21, a GPS (Global Positioning System, Global Positioning Satellite) 22, an in-vehicle camera 24, a millimeter-wave radar 26, an acceleration sensor 28, a vehicle speed sensor 30, an accelerator sensor 32, a brake sensor 34, a mode switch 36, a battery actuator 38, the battery 40, an air conditioning electronic control unit (hereinafter referred to as an air conditioning ECU) 42, an air conditioning compressor 44, the HVECU 50, an accelerator actuator 60, a brake actuator 62, a brake device 64, a display device 66, a driving state indicator 67, a meter 68, a DCM (Data Communication Module) 70, and a navigation system 80 in addition to the power source.

The GPS 22 is a device for detecting a position of a vehicle based on signals transmitted from a plurality of GPS satellites. The in-vehicle camera 24 is a camera that captures an image of the surroundings of the vehicle, and corresponds to, for example, a front camera that captures an image of the front of the vehicle, and a rear camera that captures an image of the rear of the vehicle. The millimeter-wave radar 26 detects a distance and a relative speed between the own vehicle and a vehicle ahead. The millimeter-wave radar 26 also detects a distance and a relative speed between the own vehicle and a vehicle behind.

The acceleration sensor 28 is, for example, a sensor for detecting acceleration in the longitudinal direction of the vehicle and detecting acceleration in the lateral direction of the vehicle. The vehicle speed sensor 30 detects vehicle speed based on wheel speed or the like. The accelerator sensor 32 detects accelerator position or the like according to a depression amount of an accelerator pedal by the driver. The brake sensor 34 detects a brake position or the like as a depression amount of a brake pedal by the driver. The mode switch 36 switches between the CD mode and the CS mode, and is arranged in the vicinity of a steering wheel of the driver's seat.

The battery actuator 38 detects various states of the battery 40, for example, a voltage between terminals, a charge/discharge current, and a battery temperature. The battery actuator 38 is configured to control the battery 40 based on a detected value. The battery actuator 38 calculates the state of charge SOC as a ratio of the remaining capacity of electric power dischargeable from the battery to the overall capacity of the battery based on the charge/discharge current. The battery actuator 38 also calculates an allowable maximum output power (output limit Wout) as to be output from the battery 40 and an allowable maximum input power (input limit Win) as to be input into the battery 40 based on the calculated state of charge SOC, the battery temperature, and the like. The battery 40 is configured as a chargeable and dischargeable secondary battery, and for example, a lithium ion battery, a nickel metal hydride battery, or a lead storage battery may be used.

The air conditioning ECU 42 is configured as a CPU-based microprocessor (CPU: not shown). The air conditioning ECU 42 also includes, for example, a ROM, a RAM, a flash memory, input/output ports, and a communication port. The air conditioning ECU 42 is incorporated in an air conditioning system configured to condition air in the passenger compartment. The air conditioning ECU 42 drives and controls the air conditioning compressor 44 in the air conditioning system such that the temperature of the passenger compartment becomes the set temperature.

The engine EG is configured, for example, as an internal combustion engine. The motor MG is configured, for example, as an electric motor that also functions as a generator such as a synchronous motor. The motor MG is connected to the battery 40 via an inverter (not shown), and outputs driving force by using electric power supplied from the battery 40 or charges the battery 40 with the generated electric power.

The HVECU 50 is configured as a CPU-based microprocessor (CPU: not shown). The HVECU 50 also includes, for example, a ROM, a RAM, a flash memory, input/output ports, and a communication port. The HVECU 50 sets a drive mode. The HVECU 50 also sets a target drive point (target rotation speed or target torque) of the engine EG and a torque command of the motor MG based on the set drive mode, the accelerator position from the accelerator sensor 32, the brake position from the brake sensor 34, and the input/output limit from the battery actuator 38.

The HVECU 50 performs the following processing when the hybrid vehicle is driven in the motor drive (EV drive). The HVECU 50 sets a required driving force and a required power based on the accelerator position from the accelerator sensor 32 and the vehicle speed from the vehicle speed sensor 30. The HVECU 50 sets the torque command of the motor MG to output the required driving force and the required power to the vehicle. The HVECU 50 transmits the set torque command to the accelerator actuator 60. The HVECU 50 performs the following processing when the hybrid vehicle is driven in a hybrid drive (HV drive). The HVECU 50 sets the target drive point of the engine EG and the torque command of the motor MG to output the required driving force and the required power to the vehicle. The HVECU 50 transmits the target drive point and the torque command to the accelerator actuator 60. The HVECU 50 performs the following processing in response to a depression of the brake pedal by the driver. The HVECU 50 sets the required braking force based on the brake position from the brake sensor 34 and the vehicle speed from the vehicle speed sensor 30. The HVECU 50 sets a regenerative torque command for regenerative control of the motor MG and a target braking force by the brake device based on the required braking force and the vehicle speed. The HVECU 50 transmits the torque command to the accelerator actuator 60 and transmits the target braking force to the brake actuator 62.

The accelerator actuator 60 drives and controls the engine EG and the motor MG in accordance with the target drive point and the torque command set by the HVECU 50. The accelerator actuator 60 performs intake air flow control, fuel injection control, ignition control, intake valve opening/closing timing control and the like to operate the engine EG at the target operation point (target rotation speed or target torque). Further, the accelerator actuator 60 performs switching control of the switching element of the inverter for driving the motor MG such that a torque corresponding to the torque command is output from the motor MG.

The brake actuator 62 controls the brake device 64 such that the target braking force set by the HVECU 50 is applied to the vehicle by the brake device 64. The brake control device 64 is configured, for example, as a hydraulically driven friction brake.

The display device 66 is incorporated in, for example, an installation panel in front of the driver's seat. The display device 66 displays various information. The driving state indicator 67 includes an EV indicator (not shown) and an HV indicator (not shown). The driving state indicator 67 turns on the EV indicator and turns off the HV indicator during a motor drive. The driving state indicator 67 turns off the EV indicator and turns on the HV indicator during a hybrid drive. The meter 68 is incorporated in, for example, the installation panel in front of the driver's seat.

The DCM (Data Communication Module) 70 transmits information on the own vehicle to a traffic information management center 100 and receives road traffic information from the traffic information management center 100. The information on the own vehicle includes, for example, a position, a vehicle speed, a driving power and a drive mode of the own vehicle. The road traffic information includes, for example, information on current and future traffic congestion, information on current average vehicle speed and predicted value of future average vehicle speed in each of drive sections of the drive route, information on traffic regulation, information on weather conditions, information on road conditions, and map information. The DCM 70 communicates with the traffic information management center 100 at every predetermined time interval (for example, every 30 seconds, every minute, every two minutes).

The navigation system 80 is configured to guide the own vehicle to a set destination. The navigation system 80 includes a display unit 82 and a map information database 84. The navigational system 80 communicates with the traffic information management center 100 via the DCM 70. When the destination is set, the navigation system 80 sets the route based on information on the destination, information on the current location (current location of the own vehicle) received from the GPS 22, and information stored in the map information data base 84. The navigation system 80 communicates with the traffic information management center 100 at every predetermined time interval (for example, every 3 minutes or every 5 minutes) to obtain road traffic information and performs route guidance based on the road traffic information.

When the route guidance is performed, the navigation system 80 generates a read-ahead information, such as a load information necessary for driving of each drive section, and transmits the read-ahead information to the HVECU 50 every time (or at every predetermined time interval) the road traffic information is obtained from the traffic information management center 100. The read-ahead information is generated based on, for example, information on each of drive sections of the drive route in the road traffic information obtained from the traffic information management center 100, information on driving load, the vehicle speed of the own vehicle, the driving power of the own vehicle, and the drive mode of the own vehicle. The HVECU 50 creates a drive support plan that assigns one of drive modes including the CD mode and the CS mode to each of drive sections of the drive route using the read-ahead information received from the navigation system 80 when the drive support control can be performed, and performs the drive support plan.

When update information included in the map information is obtained from the traffic information management center 100, the navigation system 80 displays the item “map update” on the display unit 82 and announces “Map information is ready to be updated. Please press the map update button.” or the like. When the item “map update” is operated in response to the notification of the map update, the navigation system 80 communicates with the traffic information management center 100 via the DCM 70, obtains the map information related to the map update, and stores the map information in the map information database 84. When the map information is updated, the navigation system 80 announces “Some functions are stopped during update of map information.” or the like.

The navigational system 80 counts an alive counter Cnb that increments by a value 1 at every predetermined time interval to inform the HVECU 50 or the like that the navigation system 80 is normally activated. The HVECU 50 obtains the alive counter Cnb from the navigation system 80 at every predetermined time interval and confirms that the navigation system 80 is normally activated. According to the embodiment, the navigation system 80 does not count the alive counter Cnb as a stop function during the update of the map information. The HVECU 50 counts an alive counter Chv that increments by a value 1 at every predetermined time interval to inform the navigation system 80 or the like that the navigation system is normally activated. The navigation system 80 obtains the alive counter Chv from the HVECU 50 at every predetermined time interval and confirms that the HVECU 50 is normally activated.

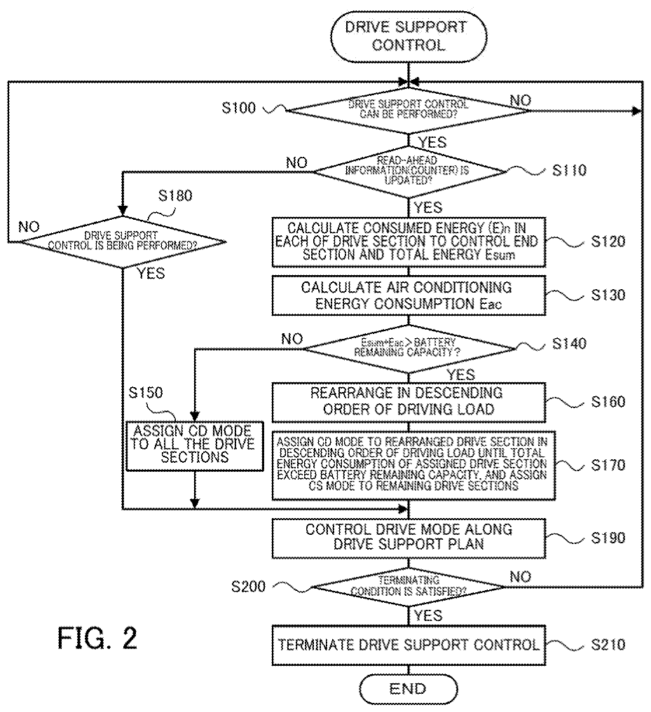

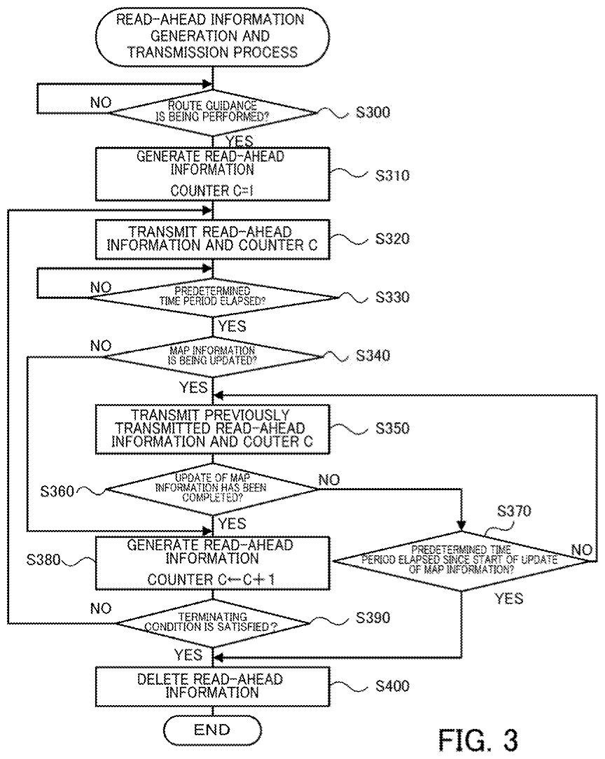

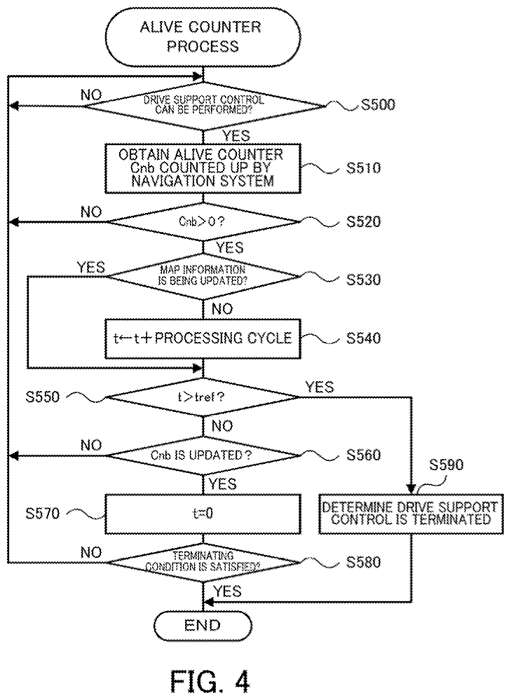

The following describes operations of the hybrid vehicle 20 of the embodiment, particularly, the operation when the map information is updated during the drive support control. FIG. 2 is a flow chart showing one example of a drive support control performed by the HVECU 50. This routine is performed when a destination is set, for example. FIG. 3 is a flowchart showing one example of a read-ahead information generation and transmission process performed by the navigation system 80. This routine is performed when a destination is set, for example. FIG. 4 is a flow chart showing one example of an alive counter process performed by the HVECU 50. This routine is performed when a destination is set, for example. The following sequentially describes the drive support control, the read-ahead information generation and transmission process, and the alive counter process.

The drive support control is described first. The HVECU 50 first determines whether the drive support control can be performed (step S100). The drive support control assigns one of drive modes including the CD mode and the CS mode to each of drive sections of the drive route and the hybrid vehicle is driven when the route from the current location to the destination is set by the navigation system 80. The HVECU 50 does not perform the drive support control when the destination is not set. The HVECU 50 does not perform the drive support control when the route guidance cannot be satisfactorily performed, for example, when there is any abnormality in the navigation system 80 or the GPS 22. Further, the HVECU 50 does not perform the drive support control when the output limit Wout that is a maximum allowable output power output from the battery 40 is small due to the low temperature of the battery 40. In this state, the engine EG may be frequently started even while the vehicle drives in the CD mode, and the vehicle cannot be driven properly in the CD mode. The HVECU 50 determines whether the drive support control can be performed at step S100 due to the circumstance described above. When it is determined at step S100 that the drive support control cannot be performed, the HVECU 50 waits until the drive support control can be performed.

When it is determined at step S100 that the drive support control can be performed, the HVECU 50 determines whether the read-ahead information transmitted and received from the navigation system 80 is updated (step S110). When it is determined that the read-ahead information is updated, the HVECU 50 calculates an energy consumption E (n) in each of drive sections of the drive route from the current location to the control end section (destination), and a total energy Esum as the sum of the each energy consumption E(n) (step S120). The energy consumption E(n) in each of drive sections can be determined based on criteria such as whether the drive section is an urban area, a suburban area, or a mountainous area. The HVECU 50 subsequently calculates an air conditioning energy consumption Eac (step S130). In the embodiment, the air conditioning energy consumption Eac is calculated by multiplying the power consumption of the air conditioning system at that time, the predetermined power consumption, the maximum power consumption of the air conditioning system, and the like by a predetermined time period (time required for driving 10 km or 15 km).

The HVECU 50 determines whether the sum of the total energy Esum and the air conditioning energy consumption Eac is larger than the remaining capacity of the battery 40 (step S140). The remaining capacity of the battery 40 can be calculated by multiplying the total capacity of the battery 40 by the state of charge SOC. When it is determined that the sum of the total energy Esum and the air conditioning energy consumption Eac is equal to or smaller than the remaining capacity of the battery 40, the HVECU 50 assigns the CD mode to all the drive sections (step S150). When it is determined that the sum of the total energy Esum and the air conditioning energy consumption Eac is larger than the remaining capacity of the battery 40, the HVECU 50 rearranges each drive sections in descending order of the driving load (energy consumption En) (step S160). The HVECU 50 subsequently assigns the CD mode to the rearranged each drive section in descending order of the driving load until the total energy consumption En of the each assigned drive sections exceeds the remaining capacity of the battery 40, and assigns the CS mode to the remaining drive sections (step S170). Accordingly, the CD mode and the CS mode are assigned to the drive route on condition that the sum of the total energy Esum and the air conditioning energy consumption Eac is larger than the remaining capacity of the battery 40. Then, the HVECU 50 controls the drive mode along the drive support plan of the assigned mode (step S190).

When it is determined at step S110 that the read-ahead information is not updated, the HVECU 50 determines whether the drive support control is being performed (step S180). When it is determined at step S180 that the drive support control is not being performed, the HVECU 50 returns the processing flow to step S100, where it is determined whether the drive support control can be performed. When it is determined at step S180 that the drive support control is being performed, the HVECU 50 controls the drive mode along the drive support plan that is created immediately before (step S190).

The HVECU 50 determines whether terminating condition of the drive support control is satisfied (step S200). The terminating condition of the drive support control includes, for example, a condition when the destination is changed, a condition when the hybrid vehicle reaches the destination, a condition when the remaining capacity of the battery 40 is changed due to charging or the like, and a condition when an operation for terminating the drive support control is performed by the driver or the like. When it is determined at step S200 that the terminating condition of the drive support control is not satisfied, the HVECU 50 returns the processing flow to step S100, where it is determined whether the drive support control can be performed. When it is determined at step S200 that the terminating condition of the drive support control is satisfied, the HVECU 50 terminates the drive support control (step S210) and terminates this routine. The HVECU 50 terminates the drive support control when the destination is changed or the remaining capacity of the battery 40 is changed due to charging or the like. The HVECU 50, however, performs the drive support control of FIG. 2 again when a drive support control should be started again.

The following describes the read-ahead information generation and transmission process of FIG. 3. The navigation system 80 first determines whether the route guidance is being performed (step S300). Whether the route guidance is being performed is determined based on whether the drive route is set and the route guidance is being performed in accordance with the input of the destination. When it is determined at step S300 that the route guidance is not being performed, the navigation system 80 waits until the route guidance is performed.

When it is determined at step S300 that the route guidance is being performed, the navigation system 80 generates the read-ahead information and sets a counter C for the read-ahead information to a value 1 (step S310). As described above, the read-ahead information includes information on each of drive sections of the drive route, information on driving load in the road traffic information obtained from the traffic information management center 100, and load information necessary for driving each drive section based on the vehicle speed of the own vehicle, the driving power of the own vehicle, and the drive mode of the own vehicle.

The navigation system 80 transmits the generated read-ahead information and the counter C to the HVECU 50 (step S320). The navigation system. 80 waits for a predetermined time period to elapse (step S330) and determines whether the map information is being updated (step S340). The predetermined time period described above is an interval (for example, 3 minutes or 5 minutes) at which the navigation system 80 communicates with the traffic information management center 100 to obtain road traffic information.

When it is determined at step S340 that the map information is not being updated, the navigation system 80 generates the read-ahead information and increments the counter C for the read-ahead information by a value 1 (step S380), and determines whether the terminating condition of the drive support control is satisfied (step S390). When it is determined that the terminating condition of the drive support control is not satisfied, the navigation system 80 returns the processing flow to step S320, where the read-ahead information and the counter C is transmitted to the HVECU 50. Accordingly, when the map information is not being updated, the navigation system 80 repeatedly performs the process of generating the read-ahead information every time the predetermined time period elapses, incrementing the counter C, and transmitting the read-ahead information and the counter C to the HVECU 50. As described above, when the map information is not being updated, the navigation system 80 generates the read-ahead information at every predetermined time interval and increments the counter C. On the other hand, the HVECU 50 makes an affirmative determination at step S110 every time the read-ahead information is updated in the drive support control of FIG. 2, performs the process of step S120 to S170, and controls the drive mode along the created drive support plan.

When it is determined at step S390 that the terminating condition of the drive support control is satisfied, the navigation system 80 deletes (erases) the read-ahead information or the like (step S400) and terminates this routine.

When it is determined at step S340 that the map information is being updated, the navigation system 80 transmits the previously transmitted read-ahead information and the counter C to the HVECU 50 (step S350). That is, the navigation system 80 transmits the read-ahead information and the counter C generated immediately before the start of update of the map information. The navigation system 80 subsequently determines whether the update of the map information has been completed (step S360). When it is determined at step S360 that the update of the map information has not been completed, the navigation system 80 determines whether a predetermined time period has elapsed since the start of the update of the map information (step S370). As the “predetermined time period”, a time slightly longer than the normal time period required for update of the map information can be applied. That is, the processing of step S370 may be considered as a process of determining whether some kind of abnormality is possibly occurred in updating the map information. When it is determined at step S370 that the predetermined time period has not elapsed since the start of the update of the map information, the navigation system 80 returns the processing flow to step S350, where the previously transmitted read-ahead information and the counter C is transmitted to the HVECU 50. Accordingly, the navigation system 80 repeatedly transmits the read-ahead information and the counter C generated immediately before start of update of the map information to the HVECU 50 until the completion of update of the map information. As described above, during the update of the map information, the navigation system 80 transmits the read-ahead information and the counter C generated immediately before the start of the update of the map information to the HVECU 50. On the other hand, the HVECU 50 makes a negative determination at step S110 since the read-ahead information is not updated in the drive support control of FIG. 2. The HVECU 50 controls the drive mode along the drive support plan created immediately before the start of the update of the map information without performing the processing of step S120 to S170.

When it is determined at step S370 that the predetermined time period has elapsed since the start of the update of the map information, the navigation system 80 determines that some kind of abnormality is possibly occurred, deletes (erases) the read-ahead information or the like (step S400) and terminates this routine.

In the read-ahead information generation and transmission process of FIG. 3, the navigation system 80 transmits the read-ahead information and the counter C generated immediately before the start of the update of the map information to the HVECU 50 during the update of the map information. Therefore, the read-ahead information transmitted to the HVECU 50 is not updated. The HVECU 50 controls the drive mode along the drive support plan that is created immediately before, when the read-ahead information is not updated. Accordingly, even while the navigation system 80 is updating the map information, the HVECU 50 can continue the drive support control. The navigation system 80 deletes (erases) the read-ahead information when the update of the map information has not been completed by elapse of the predetermined time period since the start of the update of the map information. This configuration thus prevents the drive support plan from being created and performed based on inappropriate read-ahead information.

The following describes the alive counter process performed by the HVECU 50 as illustrated in FIG. 4. As described above, the navigation system 80 counts up the alive counter Cnb by a value 1 at every predetermined time interval (for example, 100 msec) while the navigation system is normally activated. On the other hand, the navigation system 80 does not count up the alive counter Cnb during the update of the map information.

In the alive counter process of FIG. 4, the HVECU 50 first determines whether the drive support control can be performed (step S500). The determination of whether the drive support control can be performed is described in detail at step S100 of the drive support control in FIG. 2. When it is determined at step S500 that the drive support control cannot be performed, the HVECU 50 waits until the drive support control can be performed.

When it is determined at step S500 that the drive support control can be performed, the HVECU 50 obtains the alive counter Cnb that is counted up by the navigation system 80 (step S510), and determines whether the alive counter Cnb is larger than a value 0 (step S520). When it is determined at step S520 that the alive counter Cnb is the value 0, the HVECU 50 determines that the navigation system 80 is before normal activation, and returns the processing flow to step S500, where it is determined whether the drive support control can be performed.

When it is determined at step S520 that the alive counter Cnb is larger than the value 0, the HVECU 50 determines whether the map information is being updated by the navigation system 80 (step S530). This determination may be made based on information on start and completion of the update of the map information transmitted from the navigation system 80.

When it is determined at step S530 that the map information is not being updated by the navigation system 80, the HVECU 50 adds a processing cycle of repeatedly performing the alive counter process to a timer t (step S540), and determines whether the timer t is larger than a threshold value tref (step S550). The timer t is counted from a value 0 after the alive counter Cnb is counted up when the map information is not being updated by the navigation system 80. During the update of the map information, the timer t holds the value of when the update of the map information is started. As the “threshold value tref”, a time obtained by adding the processing cycle of repeatedly performing the alive counter process to the time interval for counting up the alive counter Cnb by the navigation system 80 or slightly longer can be applied. Accordingly, when the map information is not being updated and the alive counter Cnb is normally counted up by the navigation system 80, the HVECU 50 makes the negative determination at step S550.

When it is determined at step S550 that the timer t is equal to or smaller than the threshold value tref (the HVECU 50 makes negative determination), the HVECU 50 determines whether the alive counter Cnb is updated (step S560). As described above, the alive counter Cnb is counted up by the value 1 at every predetermined time interval (e.g., 100 msec) while the navigation system 80 is normally activated. The processing of step S560 accordingly determines whether the alive counter Cnb is counted up. When it is determined at step S560 that the alive counter Cnb is not updated, the HVECU 50 returns the processing flow to step S500, where it is determined whether the drive support control can be performed. When it is determined at step S560 that the alive counter Cnb is updated, the HVECU50 sets the timer t to a value 0 (step S570) and determines whether the terminating condition of the drive support control is satisfied (step S580). The determination of whether the terminating condition of the drive support control is satisfied is described in detail at step S190 of the drive support control in FIG. 2. When it is determined at step S580 that the terminating condition of the drive support control is not satisfied, the HVECU 50 returns the processing flow to step S500, where it is determined whether the drive support control can be performed. When it is determined at step S580 that the terminating condition of the driving support control is satisfied, the HVECU 50 terminates the alive counter process of FIG. 4.

When it is determined at step S550 that the timer t is larger than the threshold value tref (the HVECU 50 makes affirmative determination), the HVECU 50 determines that the drive support control should be terminated because the alive counter Cnb is not counted up normally by the navigation system 80 (step S590). The HVECU 50 then terminates the alive counter process of FIG. 4.

When it is determined at step S530 that the map information is being updated by the navigation system 80, the HVECU 50 determines whether the timer t is larger than the threshold value tref (step S550) without adding the processing cycle of repeatedly performing the alive counter process to the timer t. As the value of the timer t, the value when the update of the map information is started is held. The HVECU 50 accordingly makes the negative determination at step S550. When the negative determination (determination that the timer t is equal to or smaller than the threshold value tref) is made at step S550, the HVECU 50 determines whether the alive counter Cnb is updated (step S560). As described above, the navigation system 80 does not count up the alive counter Cnb during the update of the map information. The HVECU 50 accordingly makes the negative determination at step S560 and returns the processing flow to step S500, where it is determined whether the drive support control can be performed. The processing of step S500 to S530, S550, and S560 are thus repeatedly performed during the update of the map information.

In the alive counter process of FIG. 4, when the map information is not being updated by the navigation system 80, the HVECU 50 obtains the alive counter Cnb that is counted up by the navigation system 80 and confirms that the alive counter Cnb is counted up. When the alive counter Cnb is not counted up, the HVECU 50 determines that some kind of abnormality is occurred in the navigation system 80 and terminates the drive support control. This configuration thus may avoid performing inappropriate drive support control based on some kind of abnormality occurred in the navigation system 80. During the update of the map information, the HVECU 50 holds the timer t to a value when the update of the map information is started. This configuration may thus avoid the confirmation that the alive counter Cnb is counted up. Accordingly, it is possible to prevent the drive support control from being terminated due to the fact that the alive counter Cnb is not counted up during the update of the map information. As a result, it is possible to terminate the drive support control due to the fact that the alive counter Cnb is not counted up except during the update of the map information. Further, it is possible to avoid inconvenience such that the user feels strange by not terminating the drive support control.

In the hybrid vehicle 20 of the embodiment, the navigation system 80 generates the read-ahead information, and the HVECU 50 creates the drive support plan and performs the drive support control. The navigation system 80 and the HVECU 50 may, however, be configured as a single electronic controller and this single electronic controller may generate read-ahead information and drive support plan and perform drive support control.

In the hybrid vehicle 20 of the embodiment, the navigation system 80 sets the drive route from the current location to the destination using the map information data base 84 based on information on the current location and the destination. A modification may, however, set the drive route from the current location to the destination in cooperation with the traffic information management center 100. The navigation system 80 may set the drive route by transmitting the information on the current location and the destination to the traffic information management center 100 and receiving the drive route set based on the information on the current location and the destination from the traffic information management center 100.

In the hybrid vehicle 20 of the embodiment, the navigation system 80 generates, for example, load information necessary for driving each drive section based on road traffic information obtained from the traffic information management center 100 every time road traffic information is obtained (or at every predetermined time interval). A modification may, however, store road traffic information in advance and generate the read-ahead information based on the road traffic information stored at every predetermined time interval.

In the hybrid vehicle 20 of the embodiment, the navigation system 80 counts up the alive counter Cnb and the HVECU 50 confirms that the alive counter Cnb is counted up by the navigation system 80. This is, however, not restrictive, but such confirmation may not be performed.

In the hybrid vehicle of the present disclosure, the control device may be programmed to delete the read-ahead information that is stored in advance, when update of the map information has not been completed by elapse of a period time period since a start of the update of the map information. After elapse of the predetermined time period, the read-ahead information generated immediately before the start of the update of the map information may be inappropriate. However, by deleting the read-ahead information, it is possible to prevent the drive support plan from being created and performed based on the inappropriate read-ahead information. As the “predetermined time period”, a time slightly longer than a normal time period required for update of the map information can be applied.

In the hybrid vehicle of the present disclosure, the control device may be programmed to include a navigation system configured to obtain the road traffic information by exterior communication; and a drive support controller programmed to create the drive support plan and to perform the drive support control. The navigation system may include a system configured to generate the read-ahead information, to send the generated read-ahead information to the drive support controller, to stop the generation of the read-ahead information during update of the map information by exterior communication, and to send the read-ahead information that is generated immediately before a start of the update of the map information, to the drive support controller. The drive support controller may be programmed to create the drive support plan at every predetermined timing, based on the read-ahead information received from the navigation system. In this case, the navigation system may have an alive counter that counts up at every predetermined time interval during normal activation of the system but does not count up during update of the map information. The drive support controller may be programmed to confirm that the navigation system is normally activated, based on the alive counter, except during update of the map information. As a result, the drive support control can be terminated because the alive counter is not counted up except during the update of the map information. In addition, it is possible to avoid inconveniences such that the user feels strange due to not terminate the drive support control.

The following describes the correspondence relationship between the primary elements of the above embodiment and the primary elements of the disclosure described in Summary. In the embodiment, the engine EG corresponds to the “engine”, the motor MG corresponds to the “motor”, the battery 40 corresponds to the “battery”, and the HVECU 50 and the navigation system 80 correspond to the “control device”. Further, the navigation system 80 corresponds to the “navigation system” and the HVECU 50 corresponds to the “drive support controller”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the hybrid vehicle and so on.

1. A hybrid vehicle, comprising:
an engine;
a motor;
a battery;
map information; and
a control device programmed to set a drive route from a current location to a destination, to create a drive support plan that assigns one of drive modes including a CD mode and a CS mode to each of drive sections of the drive route, and to perform drive support control that causes the hybrid vehicle to be driven along the drive support plan,
wherein the control device comprises a device configured to generate read-ahead information that is required for creation of the drive support plan, based on road traffic information at every predetermined timing and to perform a drive support plan that is based on the read-ahead information generated immediately before a start of update of the map information, during the update of the map information by exterior communication.

2. The hybrid vehicle according to claim 1,
wherein the control device is programmed to delete the read-ahead information that is stored in advance, when update of the map information has not been completed by elapse of a predetermined time period since a start of the update of the map information.

3. The hybrid vehicle according to claim 1,
wherein the control device comprises a navigation system configured to obtain the road traffic information by exterior communication; and a drive support controller programmed to create the drive support plan and to perform the drive support control, wherein
the navigation system comprises a system configured to generate the read-ahead information, to send the generated read-ahead information to the drive support controller, to stop the generation of the read-ahead information during update of the map information by exterior communication, and to send the read-ahead information that is generated immediately before a start of the update of the map information, to the drive support controller, and
the drive support controller is programmed to create the drive support plan at every predetermined timing, based on the read-ahead information received from the navigation system.

4. The hybrid vehicle according to claim 3,
wherein the navigation system has an alive counter that counts up at every predetermined time interval during normal activation of the system but does not count up during update of the map information, and
the drive support controller is programmed to confirm that the navigation system is normally activated, based on the alive counter, except during update of the map information.

5. The hybrid vehicle according to claim 2,
wherein the control device comprises a navigation system configured to obtain the road traffic information by exterior communication; and a drive support controller programmed to create the drive support plan and to perform the drive support control, wherein
the navigation system comprises a system configured to generate the read-ahead information, to send the generated read-ahead information to the drive support controller, to stop the generation of the read-ahead information during update of the map information by exterior communication, and to send the read-ahead information that is generated immediately before a start of the update of the map information, to the drive support controller, and
the drive support controller is programmed to create the drive support plan at every predetermined timing, based on the read-ahead information received from the navigation system.

6. The hybrid vehicle according to claim 5,
wherein the navigation system has an alive counter that counts up at every predetermined time interval during normal activation of the system but does not count up during update of the map information, and
the drive support controller is programmed to confirm that the navigation system is normally activated, based on the alive counter, except during update of the map information.

7. The hybrid vehicle according to claim 1,
wherein the road traffic information comprises information obtained by exterior communication.
